(19) United States
(12) Patent Application Publication
(10) Pub. No.: US 2021/0254785 A1
(43) Pub. Date: Aug. 19, 2021

(54) Support Element, Assembly And Method Of Forming Assembly

(71) Applicant: BBA S.r.l., CENTOBUCHI DI MONTEPRANDONE (AP) (IT)

(72) Inventor: Paul Hanratty, Southampton (GB)

(21) Appl. No.: 17/179,572

(22) Filed: Feb. 19, 2021

(30) Foreign Application Priority Data
Feb. 19, 2020 (US) 10 2020 104 431.3
May 13, 2020 (EP) 20 174 305.1

(51) Int. Cl. F16M 13/02

(52) U.S. Cl. CPC F16M 13/02

(57) ABSTRACT

A support element having a support sleeve and a bearing means for forming such a support element, an arrangement having such a support element and a hollow body, and a method for forming such an arrangement. The support sleeve has a through-opening which is configured in an axial direction and is mounted in the bearing means, wherein the support sleeve and the bearing means are connected together, wherein the bearing means has a shank with a first shank portion and a second shank portion adjoining the first shank portion in the axial direction, wherein the first shank portion has a holding means that protrudes radially outwardly relative to the second shank portion and is deformable radially inwardly counter to a restoring force.

### FIELD OF THE INVENTION

The present invention relates to a support element having a support sleeve and a bearing means, a bearing means for forming such a support element, an arrangement having such a support element and a hollow body, and a method for forming such an arrangement.

### BACKGROUND OF THE INVENTION AND RELATED ART

In practice, when axial forces act on a hollow body, for example as a result of fastening a further component to this body, it is often difficult to avoid a deformation of the hollow body, in particular of two opposing walls of the hollow body which are spaced apart in the axial direction. In the present case, a hollow body is to be understood as any component which has two walls which are spaced apart in the axial direction, an intermediate space being accordingly formed between these two walls. It is perfectly conceivable that a flexible and accordingly a non-dimensionally stable material, such as for example an insulating material, in particular a foam material, is arranged in the intermediate space. The hollow body does not necessarily need to have enclosing walls over the entire periphery. The hollow body may also be configured to be U-shaped, wherein the two arms of the U-shaped profile form the opposing walls which are spaced apart in the axial direction.

### OBJECT AND SUMMARY OF THE INVENTION

It is the object of the present invention to specify a support element, an arrangement and a method which solve the aforementioned difficulties.

This object is achieved by a support element as disclosed herein. This object is further achieved by a bearing means for forming such a support element as disclosed herein. The object is further achieved by an arrangement as disclosed herein. The object is further achieved by a method as disclosed herein.

The support element according to the invention is configured as follows: Support element, in particular for receiving axial forces applied by means of a fastening means, wherein the support element has a support sleeve, wherein the support sleeve has a through-opening which is configured in the axial direction, in particular for receiving the fastening means, wherein the support element has a bearing means, wherein the support sleeve is mounted in the bearing means, wherein the support sleeve and the bearing means are connected together, wherein the bearing means has a shank with a first shank portion and a second shank portion adjoining the first shank portion in the axial direction, wherein the first shank portion has a holding means, wherein the holding means protrudes radially outwardly relative to the second shank portion and is deformable radially inwardly counter to a restoring force.

After introducing such a support element into a corresponding through-opening of a wall of a component, for example a hollow body, from a first side of the wall, the holding means holds the support element in the wall and prevents an inadvertent release or falling-out of the support element from the wall. As a result, the component may be handled without particular precautions. In particular, costly fixing measures of the support element in the wall, such as for example reshaping, clinching, adhesive bonding or welding, may be dispensed with. It is perfectly conceivable that the support element is held non-positively in the wall by means of the holding means. Preferably the support element is, however, positively held in the wall by means of the holding means. Preferably, due to the restoring force, the holding means is deformed radially outwardly on a second side of the wall opposing the first side so that the holding means or at least a partial region of the holding means engages behind the wall in the axial direction after being introduced therein.

The bearing means is preferably of sleeve-like configuration.

The shank is preferably configured radially outwardly relative to the support sleeve.

Preferably, the bearing means circumferentially encloses the support sleeve.

Preferably, the bearing means comes into contact with the support sleeve in the radial direction.

It is considered as particularly advantageous if the shank circumferentially encloses the support sleeve.

In particular, the second shank portion bears against the support sleeve. In particular, the second shank portion bears circumferentially against the support sleeve.

The holding means may be configured, for example, as a circumferential bead.

The holding means may also be configured as a circumferential collar which protrudes outwardly or which is bent outwardly relative to the remaining shank.

Preferably, the support sleeve penetrates the bearing means.

In particular, the bearing means is made from an electrically insulating material or has such a material. As a result, an electrically conductive contact may be avoided between the support sleeve and further components, for example a wall in which the support element is arranged.

The bearing means or at least the holding means preferably consists of an elastically deformable material.

The connection between the support sleeve and the bearing means may be, for example, a clinch connection, an adhesively bonded connection and/or a press fit.

Preferably, the second shank portion has a closed lateral surface.

It is considered as particularly advantageous if the holding means has a plurality of holding elements. The holding elements may be configured, for example, as holding lugs, as beads or as projections.

In the case of a plurality of holding elements, it is considered as particularly advantageous if these holding elements are arranged circumferentially around the support sleeve. The holding elements are preferably arranged in the same axial plane. As a result, the introduction of the support element into a through-opening of a wall is facilitated.

The holding elements are arranged, in particular, rotationally symmetrically relative to an axis configured in the axial direction Z, wherein a multiplicity n is greater than one, preferably the multiplicity n corresponds to the number of holding elements.

It is considered as particularly advantageous if the bearing means has a head portion, wherein the shank adjoins the head portion in the axial direction, wherein the head portion protrudes radially outwardly relative to the second shank portion, preferably protrudes relative to the first shank portion. The head portion serves, in particular, to prevent a further insertion of the bearing means and thus of the support element into a through-opening of a wall. Preferably, therefore, the head portion is designed such that it comes to bear against the first side of the wall from which the bearing means and/or the support element is introduced into the through-opening.

The bearing means is preferably configured in one piece. Moreover, the support sleeve is preferably configured in one piece.

In particular, the bearing means consists of a first material and the support sleeve consists of a second material, wherein the first material and the second material are different. Preferably, the second material has a greater hardness than the first material. The first material is preferably a plastics material. The second material is preferably a metal or an alloy, in particular a metal alloy. For example, the second material is a steel, a stainless steel or an aluminum alloy.

The support sleeve is preferably configured as a circular cylinder or at least partially as a circular cylinder. As a result, the support sleeve may be produced or created in a particular simple and cost-effective manner. Moreover, a retrospective introduction, in particular a plugging, into the bearing means is facilitated since no particular orientation of the components to one another has to be taken into account. In this connection, it is considered as particularly advantageous if the bearing means has a receiver for plugging in the support sleeve.

The support sleeve may of slotted configuration over the axial length thereof. This configuration permits the support sleeve to be produced by being bent from a plate-shaped material, in particular from a metal plate and/or a metal strip.

It is perfectly conceivable that the support sleeve has radially outwardly a circumferential projecting portion, wherein the first shank portion is configured between the projecting portion and the second shank portion. The support sleeve may have a circumferential projecting portion radially outwardly on the side of the head portion remote from the shank. As a result, it is possible to avoid an insertion of the support sleeve too far into the bearing means.

Preferably the radial projecting portion of the holding means, in particular of the respective holding element, increases relative to the second shank portion counter to the axial direction. In particular, the holding means, preferably the respective holding element, is of wedge-shaped configuration. As a result, an insertion of the bearing means into a through-opening of a wall is facilitated, since the increase in the cross section and/or the wedge shape promotes an action of force onto the holding means and/or the holding elements radially inwardly during insertion. As a result, the mounting of the bearing means and/or the support element in the wall is facilitated.

It is considered as particularly advantageous if the support sleeve protrudes relative to the bearing means or terminates flush with the bearing means in the axial direction and/or the support sleeve protrudes relative to the bearing means or terminates flush with the bearing means counter to the axial direction. Such designs are advantageous, in particular, if a direct contact of the support sleeve, for example for the purpose of producing an electrical connection, is intended to be possible in a simple manner.

In a preferred embodiment, the second shank portion has a portion engaging behind the support sleeve in the axial direction. This is advantageous, in particular, if a direct contact of the support sleeve is intended to be avoided in this region, for example for the purpose of electrical insulation.

Particularly preferably, the holding means has a plurality of holding elements which are configured as projections, wherein the respective projection is connected in the region of one end of the projection to the remaining shank and the other end of the respective projection is a free end. Preferably, the free end is the end remote from the second shank portion.

It is considered as advantageous if the first shank portion has a recess for receiving the projections, when the projections are deformed radially inwardly, or wherein the first shank portion in each case has a recess for receiving the respective projection, when the respective projection is deformed radially inwardly.

The recess is preferably configured as a set-back portion or through-opening.

It is also considered as advantageous if the respective recess has a tangential extent, wherein the tangential extent of the respective recess is greater than a tangential extent of the respective projection. As a result, the situation is avoided that a tangential deformation of the projection hinders a deformation of the projection radially inwardly. In this regard, a certain tangential play is provided between the recess and projection.

In a preferred embodiment, in a radially external region relative to the shank the head portion has at least one through-opening penetrating the head portion in the axial direction. Preferably, the at least one through-opening is configured adjacent to the holding means or one of the holding elements. Preferably, the head portion has a plurality of such through-openings. The through-opening and/or through-openings permit a visual monitoring of the position of the holding means and/or the holding elements. Moreover, the through-openings permit a visual monitoring of the final position of the support element after introducing the support element into a component since when correctly positioned the holding means typically should be at least partially concealed by the component.

Preferably, the head portion and the holding means are spaced apart in the axial direction. Preferably, the spacing is such that the intermediate space between the head portion and the holding means is suitable for receiving a wall of a component.

Preferably, a radial extent of the second shank portion, in particular a diameter of the second shank portion, is smaller than a radial extent and/or smaller than a diameter of a through-opening of a wall of a component into which the bearing means is intended to be introduced.

Preferably, the bearing means is an injection-molded part.

In particular, the bearing means is injection-molded onto the support sleeve, preferably directly injection-molded onto the support sleeve.

The bearing means according to the invention is suitable for forming a support element of one of the above embodiments of the support element. The features which are disclosed in connection with the support element and which relate to the bearing means correspondingly apply to the bearing means per se, i.e. even without the presence of a support element and/or without the presence of a support sleeve.

The arrangement according to the invention has a support element according to one of the above embodiments and a hollow body. The hollow body has two walls which are spaced apart in the axial direction, wherein the first wall of the two walls has a first through-opening and the second wall of the two walls has a second through-opening. Preferably the second through-opening is configured as a second through-opening opposing the first through-opening in an axial direction. The support element penetrates the first through-opening, wherein the holding means is arranged on a side of the first wall facing the second wall and the holding means engages behind the first wall on the side facing the second wall in the axial direction. As a result, a positive connection is formed, whereby a release and/or falling-out of the support element from the hollow body is avoided. As a result, the hollow body may be handled with the support element arranged therein, without the risk being present of a release or falling-out of the support element.

It is considered as particularly advantageous if the bearing means has a head portion, wherein the head portion is arranged on a side of the first wall remote from the second wall. In particular, a radial extent of the head portion is greater than a radial extent of the first through-opening. As a result, an insertion of the support element too far into the hollow body is prevented. Since the first wall is additionally arranged between the head portion and the holding elements, the support element is mounted in the wall in a manner which is particularly secure, in particular in a captive manner.

Preferably the bearing means or the support sleeve is in contact with the second wall on a side facing the first wall. As a result, the risk of a deformation and/or the extent of the possible deformation of the hollow body is reduced.

Preferably, the support sleeve is directly in contact with the second wall. This is advantageous, in particular, if an electrical contact is intended to be achieved between the second wall and the support sleeve.

Preferably, a radial extent of the second shank portion, in particular a diameter of the second shank portion, is smaller than a radial extent of the first through-opening. As a result, the introduction of the bearing means into the first through-opening is facilitated. Additionally, the support element may be slightly displaced in the radial direction, for example, in order to compensate for production tolerances, in particular regarding an alignment of the two through-openings.

Preferably, the arrangement has a fastening means, wherein the fastening means penetrates the support element, the first through-opening and the second through-opening, wherein the fastening means has one respective stop element on the sides of the two walls remote from one another, wherein the one stop element is adjustable relative to the other stop element in the axial direction.

The stop elements serve for bracing the fastening means against the hollow body. The fastening means may be, for example, a screw-nut arrangement or an arrangement of a threaded rod and two nuts. Typically, further components are introduced between the hollow body and at least one of the stop elements, said further components being connected in this manner to the hollow body. With the bracing of the fastening means against the hollow body the support sleeve receives the forces applied by the bracing, so that a deformation of the hollow body is avoided or reduced.

The method according to the invention is suitable for forming an arrangement according to one of the preceding embodiments. The method has at least the following method steps:
providing a bearing means according to one of the preceding embodiments; and
providing a support sleeve, wherein the support sleeve is connected to the bearing means or the support sleeve is able to be connected to the bearing means, preferably is able to be plugged into the bearing means in the axial direction.

Preferably a support element having a bearing means and having a support sleeve is provided according to one of the above embodiments. The method has at least the further method steps:
providing a hollow body, wherein the hollow body has two walls which are spaced apart in the axial direction, wherein the first wall of the two walls has a first through-opening and the second wall of the two walls has a second through-opening, preferably a second through-opening opposing the first through-opening in an axial direction; and
inserting the bearing means into the first through-opening from a side of the first wall remote from the second wall, such that the holding means when inserted is initially deformed radially inwardly counter to the restoring force and, following the radially inward deformation, the holding means is deformed radially outwardly due to the restoring force, so that the holding means is arranged on a side of the first wall facing the second wall and engages behind the first wall on the side facing the second wall in the axial direction.

It is perfectly conceivable that the support sleeve and the bearing means initially form separate components, wherein following the insertion of the bearing means into the first through-opening, the support sleeve is inserted, in particular is plugged, into the bearing means.

The insertion of the bearing means into the first through-opening, in particular of the support element into the first through-opening and/or the insertion of the support sleeve into the bearing means, is preferably carried out manually. As a result, specific setting tools, forming machines, welding tools and the like may be dispensed with. Additionally, the generally required additional method steps for fastening/fixing the support sleeve in the wall are dispensed with. The use of the bearing means and/or support element according to the invention thus facilitates the secure bearing of the support sleeve in the wall.

Preferably, the first through-opening and/or the second through-opening are configured as a circular opening.

The invention comprises the following aspects:
Aspect 1: support element, in particular for receiving axial forces applied by means of a fastening means, wherein the support element has a support sleeve, wherein the support sleeve has a through-opening which is configured in the axial direction, in particular for receiving the fastening means, wherein the support element has a bearing means, wherein the support sleeve is mounted in the bearing means, wherein the support sleeve and the bearing means are connected together, wherein the bearing means has a shank with a first shank portion and a second shank portion adjoining the first shank portion in the axial direction, wherein the first shank portion has a holding means, wherein the holding means protrudes radially outwardly relative to the second shank portion and is deformable radially inwardly counter to a restoring force.
Aspect 2: support element according to aspect 1, wherein the holding means has a plurality of holding elements.
Aspect 3: support element according to aspect 1 or 2, wherein the bearing means has a head portion, wherein the shank adjoins the head portion in the axial direction, wherein the head portion protrudes radially outwardly relative to the second shank portion, preferably protrudes relative to the first shank portion.
Aspect 4: support element according to one of aspects 1 to 3, wherein the bearing means is configured in one piece and/or the support sleeve is configured in one piece.
Aspect 5: support element according to one of aspects 1 to 4, wherein the bearing means consists of a first material and the support sleeve consists of a second material, wherein the first material and the second material are different, preferably the second material has a greater hardness than the first material.
Aspect 6: support element according to one of aspects 1 to 5, wherein the support sleeve is configured as a circular cylinder.
Aspect 7: support element according to one of aspects 1 to 6, wherein the radial projecting portion of the holding means, in particular of the respective holding element, increases relative to the second shank portion counter to the axial direction, in particular the holding means, preferably the respective holding element, is of wedge-shaped configuration.
Aspect 8: support element according to one of aspects 1 to 7, wherein the support sleeve protrudes relative to the bearing means or terminates flush with the bearing means in the axial direction and/or the support sleeve protrudes relative to the bearing means or terminates flush with the bearing means counter to the axial direction.
Aspect 9: support element according to one of aspects 1 to 8, wherein the second shank portion has a portion engaging behind the support sleeve in the axial direction.
Aspect 10: support element according to one of aspects 1 to 9, wherein the holding means has a plurality of holding elements which are configured as projections, wherein the respective projection is connected in the region of one end of the projection to the remaining shank and the other end of the respective projection is a free end.
Aspect 11: support element according to aspect 10, wherein the first shank portion has a recess for receiving the projections, when the projections are deformed radially inwardly, or wherein the first shank portion in each case has a recess for receiving the respective projection, when the respective projection is deformed radially inwardly.
Aspect 12: support element according to aspect 11, wherein the respective recess has a tangential extent, wherein the tangential extent of the respective recess is greater than a tangential extent of the respective projection.
Aspect 13: support element according to one of aspects 3 to 12, wherein in a radially external region relative to the shank the head portion has at least one through-opening penetrating the head portion in the axial direction, in particular the at least one through-opening is configured adjacent to the holding means or one of the holding elements, or wherein in a radially external region relative to the shank the head portion has a plurality of through-openings penetrating the head portion in the axial direction, in particular the respective through-opening is configured in each case adjacent to one of the holding elements.
Aspect 14: support element according to one of aspects 1 to 13, wherein the bearing means is injection-molded directly onto the support sleeve.
Aspect 15: bearing means, wherein the bearing means is suitable for forming a support element according to one of aspects 1 to 14.
Aspect 16: arrangement, wherein the arrangement has a support element according to one of aspects 1 to 14, and a hollow body, wherein the hollow body has two walls which are spaced apart in the axial direction, wherein the first wall of the two walls has a first through-opening and the second wall of the two walls has a second through-opening, preferably a second through-opening opposing the first through-opening in an axial direction, wherein the support element penetrates the first through-opening, wherein the holding means is arranged on a side of the first wall facing the second wall and the holding means engages behind the first wall on the side facing the second wall in the axial direction.
Aspect 17: arrangement according to aspect 16, wherein the bearing means has a head portion, wherein the head portion is arranged on a side of the first wall remote from the second wall.
Aspect 18: arrangement according to aspect 16 or 17, wherein the bearing means or the support sleeve is in contact with the second wall on a side facing the first wall.
Aspect 19: arrangement according to one of aspects 16 to 18, wherein the arrangement has a fastening means, wherein the fastening means penetrates the support element, the first through-opening and the second through-opening, wherein on the sides of the two walls remote from one another the fastening means has in each case a stop element, wherein the one stop element is adjustable relative to the other stop element in the axial direction.
Aspect 20: method for forming an arrangement according to one of aspects 16 to 19, wherein the method has the following method steps:
   providing a bearing means according to aspect 15;
   providing a support sleeve, wherein the support sleeve is connected to the bearing means or the support sleeve is able to be connected to the bearing means, preferably is able to be plugged into the bearing means in the axial direction;
   providing a hollow body, wherein the hollow body has two walls which are spaced apart in the axial direction, wherein the first wall of the two walls has a first through-opening and the second wall of the two walls has a second through-opening, preferably a second through-opening opposing the first through-opening in an axial direction; and
   inserting the bearing means into the first through-opening from a side of the first wall remote from the second wall, such that the holding means when inserted is initially deformed radially inwardly counter to the restoring force and, following the radially inward deformation, the holding means is deformed radially outwardly due to the restoring force, so that the holding means is arranged on a side of the first wall facing the second wall and engages behind the first wall on the side facing the second wall in the axial direction.
Aspect 21: method according to aspect 20, wherein the support sleeve and the bearing means form separate components, wherein the support sleeve, following the insertion of the bearing means into the first through-opening, is inserted, in particular plugged, into the bearing means.
Aspect 22: method according to one of aspects 20 or 21, wherein the insertion of the bearing means into the first through-opening and/or the insertion of the support sleeve into the bearing means is carried out manually.

### BRIEF DESCRIPTION OF THE DRAWING FIGURES

The invention is described in more detail with reference to the following drawing figures, without being limited thereto.

FIG. 1 shows a first embodiment of a support element in a view according to the arrow I in FIG. 2.

FIG. 2 shows the support element in a sectional view according to the line A-A in FIG. 1.

FIG. 3 shows the support element according to FIG. 1 in a view according to the arrow III in FIG. 4.

FIG. 4 shows the support element in a view according to the arrow IV in FIG. 3.

FIG. 5 shows the support element in a view according to the arrow V in FIG. 4,

FIG. 6 shows an arrangement of a hollow body and the first embodiment of the support element in a view according to the arrow VI in FIG. 7.

FIG. 7 shows the arrangement in a sectional view according to the line B-B in FIG. 6.

FIG. 8 shows an arrangement of a hollow body and the first embodiment of the support element in a sectional view.

FIG. 9 shows a bearing means of the first embodiment of the support element in a view according to the arrow IX in FIG. 10.

FIG. 10 shows the bearing means in a sectional view according to the line A-A in FIG. 9.

FIG. 11 shows the bearing means according to FIG. 9 in a perspective view.

FIG. 12 shows a second embodiment of the support element in a view according to the arrow XII in FIG. 13.

FIG. 13 shows the support element in a sectional view according to the line A-A in FIG. 12.

FIG. 14 shows the support element according to FIG. 12 in a view according to the arrow XIV in FIG. 15.

FIG. 15 shows the support element in a view according to the arrow XV in FIG. 14.

FIG. 16 shows the support element in a view according to the arrow XVI in FIG. 15.

FIG. 17 shows a third embodiment of the support element in a view according to the arrow XVII in FIG. 18.

FIG. 18 shows the support element in a sectional view according to the line A-A in FIG. 17.

FIG. 19 shows the support element according to FIG. 17 in a view according to the arrow XIX in FIG. 20.

FIG. 20 shows the support element in a view according to the arrow XX in FIG. 19.

FIG. 21 shows the support element in a view according to the arrow XXI in FIG. 20.

FIG. 22 shows the bearing means of the third embodiment of the support element in a first perspective view.

FIG. 23 shows the bearing means of the third embodiment of the support element in a second perspective view.

FIG. 24 shows the bearing means of the third embodiment of the support element in a third perspective view.

FIG. 25 shows a fourth embodiment of the support element in a view according to the arrow XXV in FIG. 26.

FIG. 26 shows the support element in a sectional view according to the line A-A in FIG. 25.

FIG. 27 shows the support element according to FIG. 25 in a view according to the arrow XXVII in FIG. 28.

FIG. 28 shows the support element in a view according to the arrow XXVIII in FIG. 27.

FIG. 29 shows the support element in a view according to the arrow XXIX in FIG. 28.

FIG. 30 shows a fifth embodiment of the support element in a perspective view.

FIG. 31 shows a support sleeve of the fifth embodiment of the support element in a perspective view.

### DETAILED DESCRIPTION OF EMBODIMENTS OF THE INVENTION

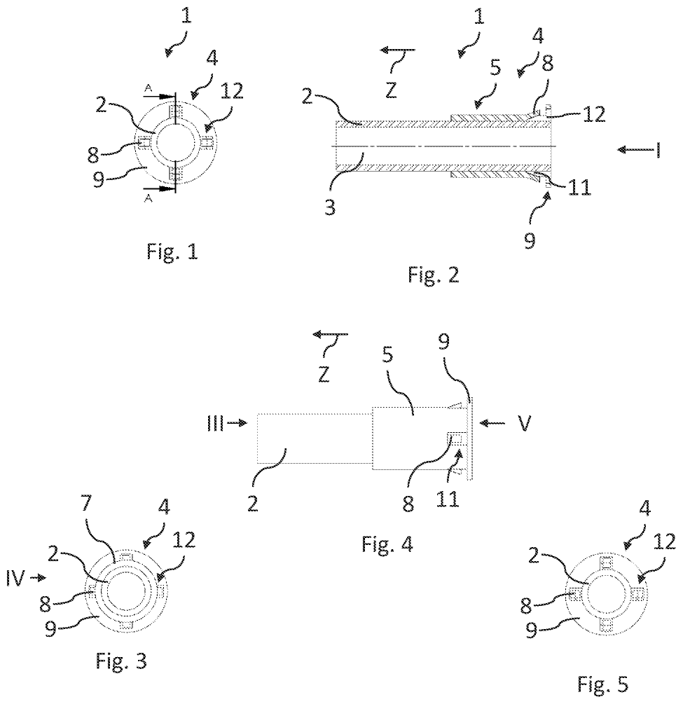

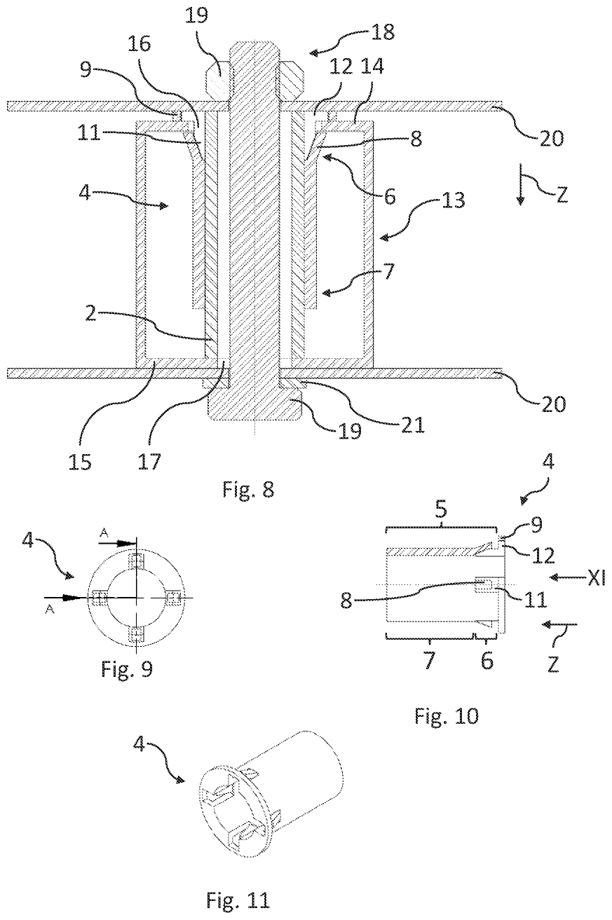

FIGS. 1 to 5 show a support element 1, in particular for receiving axial forces applied by means of a fastening means 18 (see FIG. 8), wherein the support element 1 has a support sleeve 2, wherein the support sleeve 2 has a through-opening 3 which is configured in the axial direction Z, in particular for receiving the fastening means 18, wherein the support element 1 has a bearing means 4, wherein the support sleeve 2 is mounted in the bearing means 4, wherein the support sleeve 2 and the bearing means 4 are connected together, wherein the bearing means 4 has a shank 5 with a first shank portion 6 (see FIG. 8) and a second shank portion 7 adjoining the first shank portion 6 in the axial direction Z, wherein the first shank portion 6 has a holding means, wherein the holding means protrudes radially outwardly relative to the second shank portion 7 and is radially inwardly deformable counter to a restoring force.

The bearing means 4 is of sleeve-like configuration. The bearing means 4 is in contact with the support sleeve 2 in the radial direction. The second shank portion 7 bears circumferentially against the support sleeve 2. In the present case the support sleeve 2 penetrates the bearing means 4.

In the present case the holding means has a plurality of holding elements 8.

The bearing means 4 has a head portion 9, wherein the shank 5 adjoins the head portion 9 in the axial direction Z, wherein the head portion 9 protrudes radially outwardly relative to the first shank portion 6.

The bearing means 4 and the support sleeve 2 are configured in each case in one piece.

The bearing means 4 consists of a first material and the support sleeve 2 consists of a second material, wherein the first material and the second material are different. Preferably the second material has a greater hardness than the first material.

In particular, the first material is a plastics material and/or the second material is a metal or a metal alloy. Preferably the first material is an electrically insulating material.

In the present case, the support sleeve 2 is configured as a circular cylinder.

The support sleeve 2 may have a circumferential projecting portion on the side of the head portion 9 remote from the shank 5.

The radial projecting portion of the holding means relative to the second shank portion 7, in the present case of the respective holding element 8 relative to the second shank portion 7, increases counter to the axial direction Z. As a result, an insertion of the support element 1 and/or the bearing means 4 into a through-opening of a component, with the second shank portion 7 leading, is facilitated.

The holding elements 8 are arranged in the same axial plane and are arranged circumferentially about the support sleeve 2. The holding elements 8 are arranged rotationally symmetrically relative to an axis configured in the axial direction Z, wherein a multiplicity n is greater than one, wherein in the present case the multiplicity n corresponds to the number of holding elements 8 and thus equals four, n=4.

In the present case the support sleeve 2 protrudes relative to the bearing means 4 in the axial direction Z, and the support sleeve 2 terminates flush with the bearing means 4, in the present case the head portion 9, counter to the axial direction Z.

In the present case the holding elements 8 are configured as projections, wherein the respective projection is connected in the region of one end of the projection to the remaining shank 5 and the other of the respective projection is a free end. In the present case the free end is remote from the second shank portion 7.

The first shank portion 6 has one respective recess 11 for receiving the respective projection when the respective projection is deformed radially inwardly. In the present case the recess 11 is configured as a through-opening. However, it is also conceivable that the recess 11 is configured as a set-back portion.

In the present case, the respective recess 11 has a tangential extent, wherein the tangential extent of the respective recess 11 is greater than a tangential extent of the respective projection. As a result, the situation is avoided that a tangential deformation of the projection hinders a deformation of the projection radially inwardly. In this regard, a certain tangential play is provided between the recess 11 and the projection.

In the present case, in a radially external region relative to the shank 5 the head portion 9 has a plurality of through-openings 12 penetrating the head portion 9 in the axial direction Z, wherein the respective through-opening 12 is configured in each case adjacent to one of the holding elements 8. These through-openings 12 permit a visual monitoring of the position of the holding elements 8. Moreover, the through-openings 12 permit a visual monitoring of the final position of the support element 1 after the support element 1 is introduced into a component, since when correctly positioned the holding elements 8 are at least partially concealed by the component.

It is perfectly conceivable that the bearing means 4 is directly injection-molded onto the support sleeve 2.

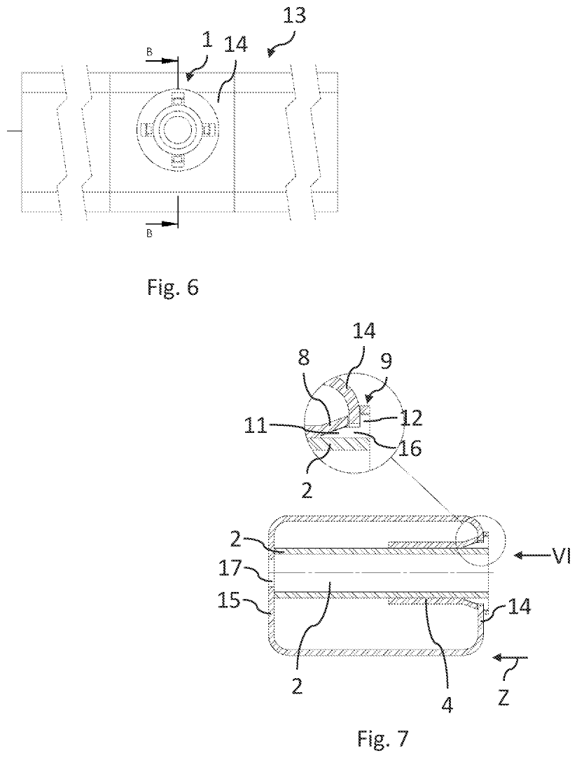

FIGS. 6 to 8 show an arrangement, wherein the arrangement has a support element 1 according to the first embodiment and a hollow body 13, wherein the hollow body 13 has two walls 14, 15 which are spaced apart in the axial direction Z, wherein the first wall 14 of the two walls 14, 15 has a first through-opening 16 and the second wall 15 of the two walls 14, 15 has a second through-opening 17, in the present case a second through-opening 17 opposing the first through-opening 16 in an axial direction Z, wherein the support element 1 penetrates the first through-opening 16, wherein the holding means, in the present case the holding elements 8, are arranged on a side of the first wall 14 facing the second wall 15, and the holding elements 8 engage behind the first wall 14 on the side facing the second wall 15 in the axial direction Z. As a result, a release and/or falling-out of the support element 1 from the hollow body 13 is avoided. As a result, the hollow body 13 may be handled without the risk of a release or falling-out being present.

Since the bearing means 4 has a head portion 9 which is arranged on a side of the first wall 14 remote from the second wall 15, the support element 1 is prevented from slipping further into the hollow body 13. Since the first wall 14 is arranged between the head portion 9 and the holding elements 8, the support element 1 is mounted in the hollow body 13 in a manner which is particularly secure, in particular in a captive manner.

Since the bearing means 4 has a smaller radial extent than the first through-opening 16 and in addition typically consists of an elastically deformable material, the support element 1 may be slightly displaced in the radial direction, for example in order to compensate for production tolerances, in particular of the two through-openings 16, 17.

In the present case the support sleeve 2 is in contact with the second wall 15 on a side facing the first wall 14.

The arrangement of FIG. 8 additionally has a fastening means 18, wherein the fastening means 18 penetrates the support element 1, the first through-opening 16 and the second through-opening 17, wherein the fastening means 18 in each case has a stop element 19 on the sides of the two walls 14, 15 remote from one another, wherein the one stop element 19 is adjustable relative to the other stop element 19 in the axial direction Z.

The stop elements 19 serve for bracing the fastening means 18 against the hollow body 13. The fastening means 18 may be, for example, a screw-nut arrangement or an arrangement of a threaded rod and two nuts. Typically further components are introduced between the hollow body 13 and at least one of the stop elements 19, said further components being able to be connected in this manner to the hollow body 13. In FIG. 8 two plate-shaped components 20 are thus connected to the hollow body 13. A washer 21 is arranged between one of the stop elements 19 and one of the plate-shaped components 20.

A method for forming an arrangement according to FIGS. 6 to 8 has the following method steps:
providing a bearing means 4;
providing a support sleeve 2, wherein the support sleeve 2 is connected to the bearing means 4 or the support sleeve 2 is able to be connected to the bearing means 4, preferably is able to be plugged into the bearing means 4 in the axial direction Z;
providing a hollow body 13, wherein the hollow body 13 has two walls 14, 15 which are spaced apart in the axial direction Z, wherein the first wall 14 of the two walls 14, 15 has a first through-opening 16 and the second wall 15 of the two walls 14, 15 has a second through-opening 17, preferably a second through-opening 17 opposing the first through-opening 16 in an axial direction Z; and
inserting the bearing means 4 into the first through-opening 16 from a side of the first wall 14 remote from the second wall 15, such that the holding means when inserted is initially deformed radially inwardly counter to a restoring force and, following the radially inward deformation, the holding means is deformed radially outwardly due to the restoring force so that the holding means is arranged on the side of the first wall 14 facing the second wall 15 and engages behind the first wall 14 on the side facing the second wall 15 in the axial direction Z.

It is perfectly conceivable that the support sleeve 2 and the bearing means 4 form separate components, wherein, following the insertion of the bearing means 4 into the first through-opening 16, the support sleeve 2 is inserted into the bearing means 4, in particular plugged therein.

The insertion of the bearing means 4 into the first through-opening 16 and/or the insertion of the support sleeve 2 into the bearing means 4 is preferably carried out manually.

FIGS. 9 to 11 show the bearing means 4 of the first embodiment of the support element 1.

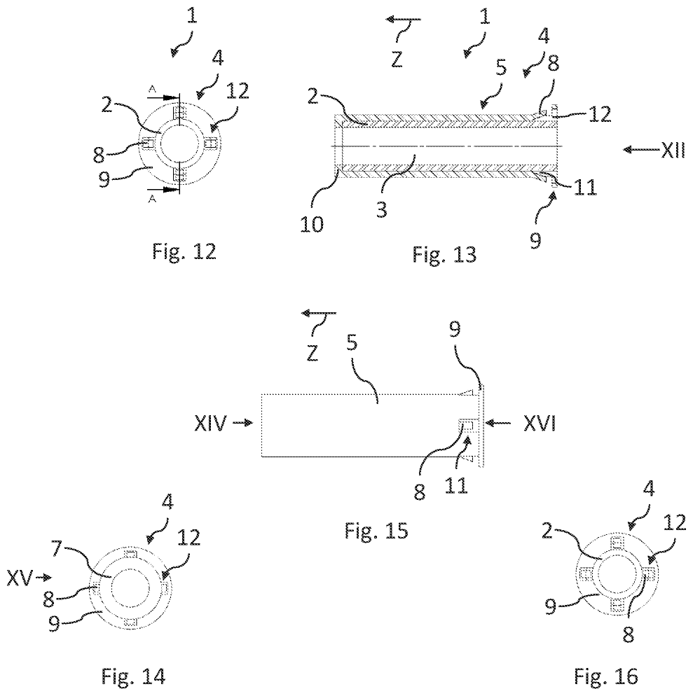

The second embodiment of the support element 1 shown in FIGS. 12 to 16 substantially differs from the first embodiment of the support element 1 by the design of the bearing means 4. The support sleeve 2 does not protrude relative to the bearing means 4. Additionally, the second shank portion 7 has a portion 10 engaging behind the support sleeve 2 in the axial direction Z. This is advantageous, in particular, if the second wall 15 is intended to be electrically insulated from the support sleeve 2.

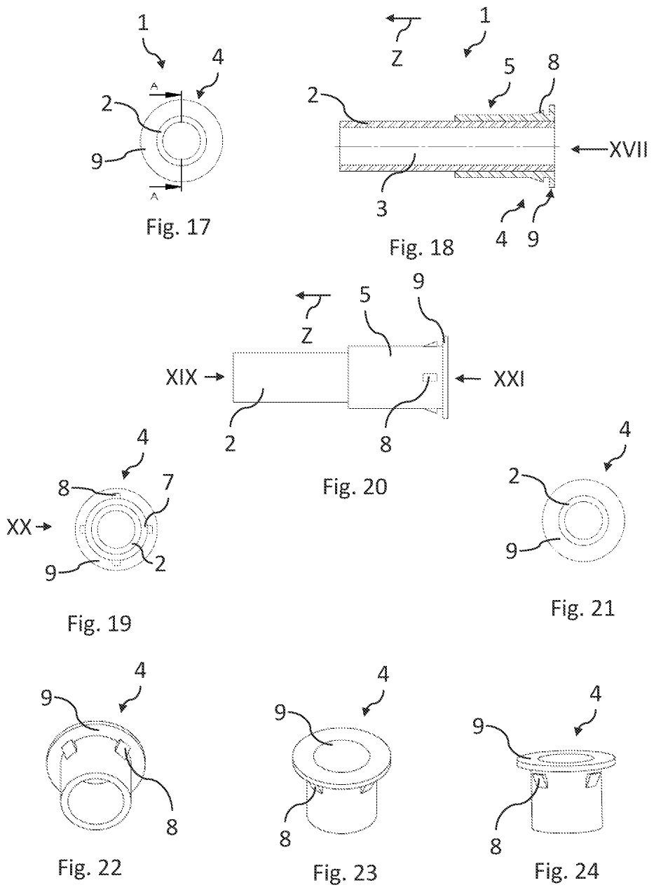

The third embodiment of the support element 1 shown in FIGS. 17 to 21 substantially differs from the first embodiment of the support element 1 by the design of the bearing means 4. The bearing means 4 has no recesses. The respective holding element 8 is additionally of wedge-shaped configuration. Moreover, the head portion 9 has no through-openings.

FIGS. 22 to 24 show the bearing means 4 of the third embodiment of the support element 1.

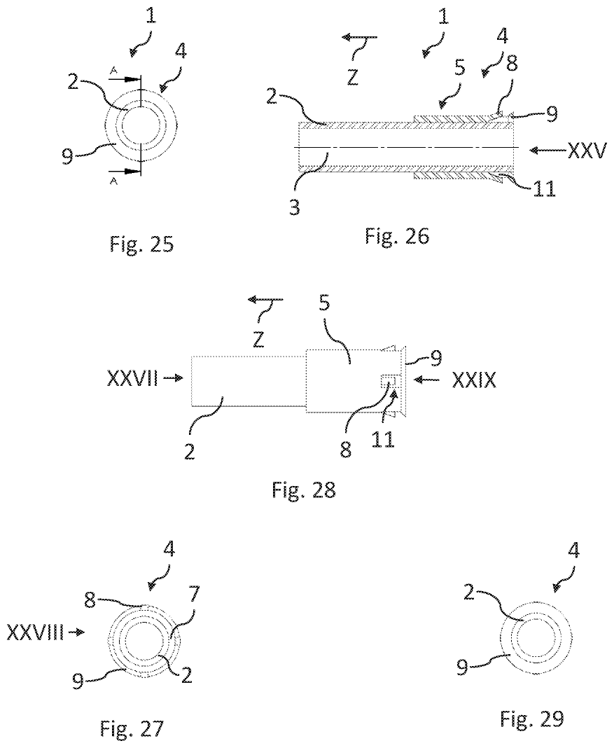

The fourth embodiment of the support element 1 shown in FIGS. 25 to 29 substantially differs from the first embodiment of the support element 1 by the design of the bearing means 4. The head portion 9 is of wedge-shaped configuration and protrudes radially outwardly only relative to the second shank portion 7 and not relative to the first shank portion 6, i.e. in the present case the holding elements 8 protrude radially outwardly relative to the head portion 9. Moreover, the head portion 9 has no through-openings.

The features disclosed in connection with the support element 1 and which relate to the bearing means 4, correspondingly apply to the bearing means 4 per se, i.e. without the presence of a support element 1.

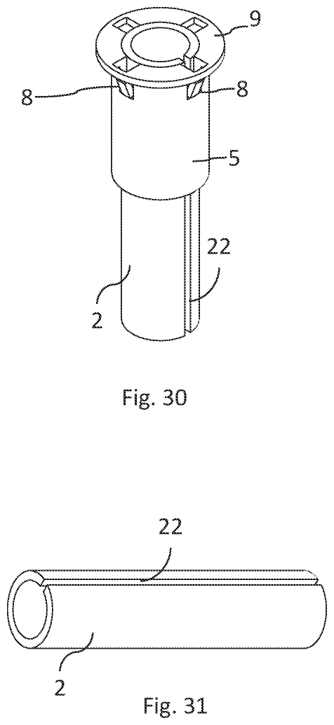

The fifth embodiment of the support element 1 shown in FIGS. 30 and 31 differs from the first embodiment of the support element 1 in that a support sleeve 2 which is provided over the entire axial length thereof with a slot 22 is used instead of a support sleeve 2 which is configured as a rotationally symmetrical tube. This support sleeve 2 is bent from a metal strip.

That which is claimed is:

1. A support element, wherein the support element has a support sleeve, wherein the support sleeve has a through-opening configured in an axial direction, for receiving a fastening means, wherein the support element has a bearing means, wherein the support sleeve is mounted in the bearing means, wherein the support sleeve and the bearing means are connected together, wherein the bearing means has a shank with a first shank portion and a second shank portion adjoining the first shank portion in the axial direction, wherein the first shank portion has a holding means, wherein the holding means protrudes radially outwardly relative to the second shank portion and is deformable radially inwardly counter to a restoring force.

2. The support element as claimed in claim 1, wherein the holding means has a plurality of holding elements.

3. The support element as claimed in claim 2, wherein the bearing means has a head portion, wherein the shank adjoins the head portion in the axial direction, wherein the head portion protrudes radially outwardly relative to the first shank portion.

4. The support element as claimed in claim 1, wherein the bearing means consists of a first material and the support sleeve consists of a second material, wherein the first material and the second material are different, and the second material has a greater hardness than the first material.

5. The support element as claimed in claim 1, wherein the radially outwardly projecting portion of the holding means increases relative to the second shank portion counter to the axial direction and is of wedge-shaped configuration.

6. The support element as claimed in claim 1, wherein the second shank portion has a portion engaging behind the support sleeve in the axial direction.

7. The support element as claimed in claim 1, wherein the holding means has a plurality of holding elements configured as projections, wherein the respective projection is connected in the region of one end of the projection to the shank and the other end of the respective projection is a free end.

8. The support element as claimed in claim 7, wherein the first shank portion has a recess for receiving the projections when the projections are deformed radially inwardly, or wherein the first shank portion has a respective recess for receiving a respective projection when the respective projection is deformed radially inwardly.

9. The support element as claimed in claim 8, wherein the respective recess has a tangential extent, wherein the tangential extent of the respective recess is greater than a tangential extent of the respective projection.

10. The support element as claimed in claim 3, wherein in a radially external region relative to the shank the head portion has at least one through-opening penetrating the head portion in the axial direction and the at least one through-opening is configured adjacent to the holding means, or wherein in the radially external region relative to the shank the head portion has a plurality of through-openings penetrating the head portion in the axial direction and a respective through-opening is configured adjacent to a respective one of the holding elements.

11. A bearing means, wherein the bearing means is suitable for forming a support element as claimed in claim 1.

12. An arrangement, wherein the arrangement has a support element as claimed in claim 1 and a hollow body, wherein the hollow body has two walls that are spaced apart in the axial direction, wherein a first wall of the two walls has a first through-opening and a second wall of the two walls has a second through-opening, wherein the support element penetrates the first through-opening, wherein the holding means is arranged on a side of the first wall facing the second wall and the holding means engages behind the first wall on the side facing the second wall in the axial direction.

13. The arrangement as claimed in claim 12, wherein at least one of the bearing means and the support sleeve is in contact with the second wall on a side facing the first wall.

14. A method for forming an arrangement as claimed in claim 12, wherein the method has the following method steps:
providing a bearing means as claimed in claim 11;
providing a support sleeve, wherein the support sleeve is configured to be connected to the bearing means in the axial direction;
providing a hollow body, wherein the hollow body has two walls spaced apart in the axial direction, wherein a first wall of the two walls has a first through-opening and a second wall of the two walls has a second through-opening, opposing the first through-opening in the axial direction;
inserting the bearing means into the first through-opening from a side of the first wall remote from the second wall, such that the holding means is initially deformed radially inwardly counter to the restoring force and, following the radially inwardly deformation, the holding means is deformed radially outwardly due to the restoring force, so that the holding means is arranged on a side of the first wall facing the second wall and engages behind the first wall on the side facing the second wall in the axial direction.

15. The method as claimed in claim 14, wherein the insertion of the bearing means into the first through-opening and/or the mounting of the support sleeve into the bearing means is carried out manually.
